(19) United States
(12) Patent Application Publication
(10) Pub. No.: US 2026/0177027 A1
(43) Pub. Date: Jun. 25, 2026

(54) POWER TAKE-OFF DEVICE AND WAVE ENERGY CONVERTER UNIT COMPRISING SUCH POWER TAKE-OFF DEVICE

(71) Applicant: Ocean Harvesting Technologies AB, Karlskrona (SE)

(72) Inventors: Mikael Sidenmark, Listerby (SE); Markus Wallentin, Alingsås (SE)

(21) Appl. No.: 19/127,675

(22) PCT Filed: Nov. 9, 2023
(86) PCT No.: PCT/SE2023/051136

§ 371 Date: May 6, 2025

(30) Foreign Application Priority Data
Nov. 10, 2022 (SE) 2251316-2

(51) Int. Cl. F03B 13/18; B63B 22/00; F03B 13/16; F03B 13/20

(52) U.S. Cl. CPC F03B 13/18; B63B 22/00; F03B 13/16; F03B 13/1875; F03B 13/1885; F03B 13/20

(57) ABSTRACT

A power take-off device for use in a wave energy converter unit has a power take-off hull connectable to a mooring device and connected to or connectable to the buoy, and a power extracting device connected to the power take-off hull. The power extracting device is adapted to extract power as the buoy moves with the waves, by applying a control force within a predetermined range. The power take-off hull has a first shell movable relatively to a second shell, and the first and second shells together define an inner volume. A seal is provided to separate the inner volume from water outside of the power take-off hull, and the differential pressure between water surrounding the power take-off hull and the inner volume provides a nearly constant pre-tension force from the first and second shells being pushed together by surrounding water pressure.

### TECHNICAL FIELD

The present disclosure relates generally to wave energy conversion and more particularly to a power take-off (PTO) device with features to provide instantly controllable PTO force to enable high energy output with wave-by-wave tuned reactive force control. A wave energy converter unit comprising a PTO device is also provided as well as a method of operating a wave energy converter.

### BACKGROUND

One challenge with wave power is to design efficient PTO devices, to enable large amounts of energy to be produced relative the size of the device, in order to achieve low cost of energy, while also ensuring reliable operation and survival in extreme wave conditions.

Wave by wave tuned reactive PTO force control, such as model predictive control, is known to provide very high performance by having the capability to control the phase of the buoy motion as well as the energy extraction optimally in every wave, considering the efficiency and constraints of the device.

To provide instant force control with high efficiency, about half the control force is provided with a nearly constant pre-tensed spring force, and the second half with a bi-directional controllable force. This reduces circulating power flows in the controllable part of the force, typically provided through an actuator connected with a motor/generator, and the associated round trip losses through these components.

### SUMMARY

An object of at least some implementations the present disclosure is to provide a wave energy converter and power take-off device with a nearly constant pre-tension force by the pressure differential between the sea water and a variable volume inside the PTO hull, the wave energy converter also being capable of limiting end stop forces to ensure surviving in waves larger than the available stroke length of the PTO.

The disclosure is based on the insight that the pressure differential of the surrounding water and the volume inside the PTO hull creates a nearly constant force that can be exploited if the PTO hull is split in two halves, one moving outside the other like a large pneumatic cylinder with a hollow piston rod.

According to a first aspect of the disclosure, a power take-off device for use in a wave energy converter unit having a buoy is provided, the power take-off device having: a power take-off hull connectable to a mooring device, the power take-off hull being connected to or connectable to the buoy, preferably by means of a mooring line, a power extracting device connected to the power take-off hull and adapted to extract power as the buoy moves with the waves, by applying a control force within a predetermined range, the power take-off device being characterized in that the power take-off hull comprises a first shell and a second shell, the first shell being movable relatively to the second shell, the first and second shells together defining an inner volume, wherein a seal is provided to separate the inner volume from water outside of the power take-off hull, wherein the differential pressure between water surrounding the power take-off hull and the inner volume is used to, during operation, provide a nearly constant pre-tension force from the first and second shells being pushed together by surrounding water pressure.

In a preferred embodiment, the seal comprises a flexible rubber membrane arranged to roll between the first and second shells during movement.

In a preferred embodiment, the seal comprises a linear seal.

In a preferred embodiment, the pre-tension force is in the range of 0.5-1.5 MN, preferably about 1.25 MN, preferably provided together with a bi-directional control force with a slightly lower amplitude, preferably about 0.25 MN lower, the two forces together providing a force control range, preferably 0.25-2.25 MN.

In a preferred embodiment, the diameter of the second shell is in the range of 1-2 meters, preferably 1.5 meters.

In a preferred embodiment, a power take-off heave system is provided with at least one pair of, preferably left and right cut, rotating ball screws, and non-rotating ball nuts being fixed in a frame, preferably with guide bushings between the ball nuts and ball screws, and preferably with a central guide pipe being attached to the ball nut frame, sliding through a linear guide bushing in the ball screw frame.

In a preferred embodiment, guide rods are arranged in parallel with the ball screws, preferably also sliding through guide bushings in the ball nut frame, to further reduce radial forces and bending moments from the ball screws.

In a preferred embodiment, a floating support bushing assembly is provided for the ball screws, the floating support bushing assembly comprising a frame of guide bushings on each side of the ball nuts with a fixed distance between the frames, preferably by means of guide pipes, preferably running on the guide rod, the floating support bushing assembly preferably being lifted by the bottom frame for the ball screws and guide rods from half the way through the up stroke, reducing the maximum free length of the ball screws above the ball nut frame to half, and the floating support bearing assembly resting on top of the ball nut frame from half the way through the down stroke, reducing the maximum free length of the ball screws below the ball nut frame to half, whereby the critical speed of the ball screws are increased, allowing faster movement velocity.

In a preferred embodiment, at least one frame with floating support bushings is provided for the ball screws on each side of the ball nut frame, is positioned on the ball screws with a scissors lift mechanism between each of the ball screw frames and the ball nut assembly, whereby the floating support bushings are always positioned evenly across the free length of the ball screw through the length of the stroke.

In a preferred embodiment, a power take-off heave system is provided with at least one pair of, preferably left and right cut, non-rotating ball screws heaving with the buoy, and rotating ball nuts held in a fixed vertical position.

According to a second aspect of the disclosure, a wave energy converter is provided comprising a power take-off device as described above, a buoy connected to the first shell of the power take-off hull and an anchor system connected to the second shell of the power take-off hull.

In a preferred embodiment, the buoy comprises a pre-tensed end-stop spring (comprising a shell with a top plate and having an inner diameter and, a rod connected to a bottom plate with a bottom link for a connection to a mooring line, and rubber cords attached between the top plate and the bottom plate, wherein the rod, having an outer diameter slightly smaller than the inner diameter of the shell, is adapted to move inside the shell, and wherein the rubber cords are mounted with pre-tension between the top and bottom plates when the rod is fully inside the shell, to provide a total force higher than the pre-determined maximum control force, preferably 2.5 MN, more preferably 2.0 MN.

In a preferred embodiment, the buoy comprises a submerge end-stop spring/damper system) comprising at least two dampers around a through hole in the buoy for the mooring line, the dampers preferably being impact buffers, preferably with a submerge buffer piston rod comprising a reservoir and a floating piston which separates oil and gas, and wherein the gas has a pre-charge pressure corresponding to a force higher than the maximum control force, whereby the buoy submerge spring/damper system is compressed by the increased force in the mooring line from the power take-off submerge end-stop dampers during buoy submerge events in large waves.

In a preferred embodiment, a slack end-stop spring/damper system is provided in the buoy in combination with the submerge end-stop spring/damper system, the slack end-stop spring/damper system preferably comprising at least two impact buffers around the through hole in the buoy for the mooring line, preferably with the piston rod containing a reservoir and a floating piston which separates oil and gas, wherein the gas has a pre-charge pressure corresponding to a force lower than the minimum control force, whereby the buoy slack spring/damper system is compressed within the force control range, extended during slack events when the force in the mooring line is lower than a minimum control force of the predetermined range, and returned to compressed state with a damping force higher than the pre-tension force after the slack event when the force in the mooring line returns.

In a preferred embodiment, an end-stop spring/damper system is provided in the buoy with a slack buffer piston rod integrated in the submerge spring/damper system, the slack buffer piston rod preferably extending from a submerge buffer piston rod of the submerge end-stop spring/damper system to operate with the same pre-charge pressure and gas volume, to provide a pre-tensed force of the slack buffer piston rod lower than a minimum control force of the predetermined range when fully compressed, whereby the slack buffer piston rod extends when the force in the mooring line is lower than the minimum control force due to a slack event, activating a snap load damper function to apply a damping force while the slack buffer piston rod returns to the compressed state when the mooring line is tensed again after the slack event and the force increases above the minimum control force, to accelerate power take-off heave motion to match a buoy velocity before the slack buffer piston rod is fully compressed and the mooring line between the buoy and power take-off becomes stiff, to reduce snap loads.

According to a third aspect of the disclosure, a method of operating a power take-off device as described above is provided, wherein the constant force provided by the differential pressure of the water surrounding the power take-off hull and the inner volume, is used in combination with a controllable bi-directional force provided by a linear actuator.

In a preferred embodiment, an average pressure of the inner volume is in the range of 0.5-1.0 bar, preferably about 0.75 bar.

In a preferred embodiment, the differential pressure is about 7.25 bar.

In summary the differential pressure device replaces a hydraulic or pneumatic cylinder and the external gas volume required to provide a nearly constant pre-tension force, with a less complex and costly solution that also reduces the size and weight of the power take-off.

### BRIEF DESCRIPTION OF THE DRAWINGS

The disclosure is now set forth, by way of example, with reference to the accompanying drawings, in which:

FIG. 1 shows a complete WEC unit with buoy, PTO device and anchor.

FIG. 2a shows a pre-tensed end-stop spring in contracted state.

FIG. 2b shows the pre-tensed end-stop spring of FIG. 2a in extended state.

FIG. 2c shows the pre-tensed end-stop spring of FIG. 2a from the top.

FIG. 2d shows a buoy with the pre-tensed end-stop spring of FIGS. 2a-c upright with the mooring line attached, in contracted state.

FIG. 2e shows the buoy with the pre-tensed end-stop spring of FIGS. 2a-c upright with the mooring line attached, in extended state.

FIG. 3 shows a buoy with a mooring spring/damper assembly comprising pre-tensed submerge spring/damper and pre-tensed slack spring/damper.

FIG. 3a shows a wave energy converter with a mooring spring/damper assembly according to FIG. 3 in the buoy during slack event.

FIG. 3b shows a wave energy converter with a mooring spring/damper assembly according to FIG. 3 in the buoy during normal operation.

FIG. 3c shows a wave energy converter with a mooring spring/damper assembly according to FIG. 3 in the buoy during submerge event.

FIG. 4 shows a sectional view of a PTO device with two rotating ball screws attached to an inner PTO shell and two fixed ball nuts attached to an outer PTO shell.

FIG. 4a shows a sectional view of the lower fixed part of the PTO device according to FIG. 4.

FIG. 4b shows a sectional view of the upper moving part of the PTO device according to FIG. 4.

FIG. 4c shows a sectional view of the PTO device according to FIG. 4 in fully contracted state of the heave system.

FIG. 4d shows a sectional view of the PTO device according to FIG. 4 in mid stroke of the heave system.

FIG. 4e shows a sectional view of the PTO device according to FIG. 4 in fully extended state of the heave system.

FIG. 4f shows a sectional view of a PTO device according to FIG. 4 with floating support for the ball screws being positioned with a scissor lift mechanism.

FIG. 5a shows a sectional view of a level system comprised in the WEC according to FIG. 1.

FIG. 5b shows a sectional view of an anchor system comprised in the WEC according to FIG. 1.

FIG. 6 shows a sectional view of a PTO device with two non-rotating ball screws attached to an outer PTO shell and two rotating ball nuts attached to an inner PTO shell.

FIG. 6a shows a sectional view of the lower fixed part of the PTO device according to FIG. 6.

FIG. 6b shows a sectional view of the upper moving part of the PTO device according to FIG. 6.

FIG. 6c shows a sectional view of the PTO device according to FIG. 6 in fully contracted state of the heave system.

FIG. 6d shows a sectional view of the PTO device according to FIG. 6 in mid stroke of the heave system.

FIG. 6e shows a sectional view of the PTO device according to FIG. 6 in fully extended state of the heave system.

FIG. 7 shows a sectional view of a PTO device according to FIG. 4 with one ball screw replaced with a guide rod.

FIG. 8a shows a sectional view of a fully contracted PTO device according to FIG. 7 with the addition of a floating support frame.

FIG. 8b shows a sectional view of a PTO device according to FIG. 8a. in mid-stroke.

FIG. 8c shows a sectional view of a PTO device according to FIG. 8a. in fully extended position.

FIG. 9 shows a sectional view of a PTO device with only one ball screw.

FIG. 9a shows as sectional view of the lower fixed part of the PTO device according to FIG. 7.

FIG. 9b shows as sectional view of the upper moving part of the PTO device according to FIG. 7.

### DETAILED DESCRIPTION

In the following, a wave energy converter (WEC) with a power take-off (PTO) device using differential pressure to provide a nearly constant pre-tension spring force in combination with a linear actuation system to provide bi-directional control force, and a buoy with integrated pre-tensed end stop spring, will be described in detail.

When references are made to directions, such as “up” or “top”, these refer to the directions shown in the figures, i.e., after installation of the WEC unit at sea.

A heave system comprises a pre-tensioning system and a linear actuator, the pre-tensioning system comprising a split PTO hull with an outer shell moving up and down with the buoy on the surface, around an inner shell attached with the anchor, whereby a nearly constant pre-tension spring force proportional to the pressure differential between the water outside and the internal volume of the PTO hull and the cross section area of the inner shell is provided, and the linear actuators, preferably two or more ball screws, adapted to provide bi-directional force.

The heave system provides instant force control capability within a pre-determined force range, from close to zero when the linear actuator acts in the opposite direction to the pre-tension spring force, and up to a pre-determined maximum control force when the linear actuator acts in the same direction as the pre-tension spring force.

It is preferred that the power take-off device also provides a linear guiding system to ensure that the outer and inner shells of the PTO hull move linearly relative to each other, by having a center guide attached with the outer shell interconnected with the buoy, running through a guide bushing attached with the inner shell interconnected with the anchor, whereby radial loads and bending moments on the ball screw actuators are reduced.

The power take-off device also provides a floating support mechanism, preferably positioned by means of a scissors mechanism, for the ball screw actuators to reduce the free length of the ball screws above and below the ball nut assembly, whereby the critical speed is increased to allow higher movement velocity of the heave system.

The power take-off device preferably also provides an end-stop cushioning system comprising: a first stage end-stop cushioning device adapted to apply, in an end-stop operation, an additional deceleration force on the power take-off device above the predetermined maximum control force, preferably impact buffer, to stop the movement of the linear actuation system, and a second stage pre-tensed submerge end stop spring/damper device, preferably located on the buoy on the surface, preferably impact buffer, adapted to allow the buoy to move up relative to the mooring line during a submerge end-stop operation after the first stage has been activated and when the force in the mooring line is higher than the above said predetermined maximum control force, to stop the buoy motion and then hold the buoy submerged through the crest of a large wave, with lower maximum force in the mooring line; the second stage of the end-stop cushioning device in the buoy, preferably also comprising a pre-tensed slack end stop spring/damper, preferably impact buffer, adapted to allow the buoy to move up relative to the mooring line when the force in the mooring line is lower than the pre-determined minimum control force range, to activate a snap load damper, activating a snap load damper function to apply a damping force while the slack spring/damper returns to the compressed state when the mooring line is tensed again after the slack event and the force increases above the minimum control force, to accelerate the power take-off heave motion to match the buoy velocity before the slack spring/damper is fully compressed and the link between the buoy and power take-off becomes stiff, to reduce snap loads.

A level system is furthermore provided, preferably by means of cylinder, preferably actuated with a power screw, preferably a roller screw journalled with a thrust bearing at the top of the cylinder together with an electric motor arranged to rotate the roller screw, and a roller nut fixed at the top of the extending rod, whereby the position of the rod is adjusted by controlling the motor to rotate the screw to position the height of the PTO above the anchor, to align the heave system optimally to the sea level, e.g. when the tidal level changes.

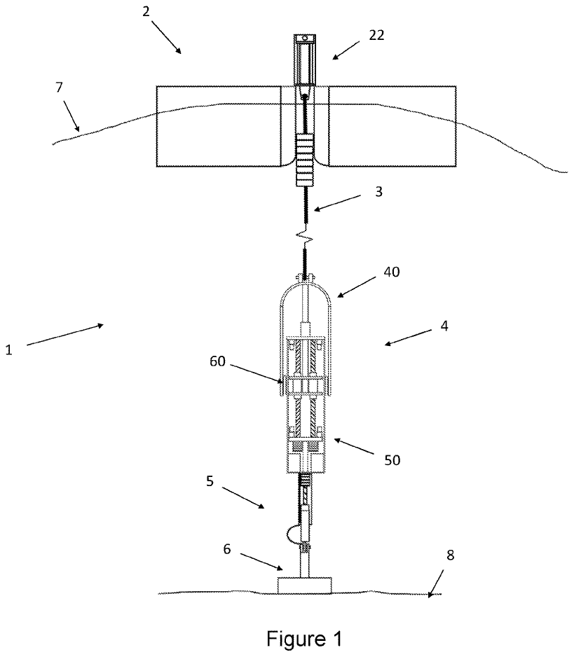

With reference to FIG. 1, the design and operation of a WEC unit 1 will now be explained in general terms. The WEC unit 1 comprises a power take-off (PTO) device 4 and a buoy 2 interconnected by means of a pre-tensed end-stop spring 22 and mooring line 3. The PTO device 4 comprises a first outer PTO unit 40 with the heaving part of the PTO device 4 connected with the mooring line and a second inner unit 50 with the fixed part of the PTO device 4 interconnected with a mooring device or anchor system 6 by means of the level cylinder 5.

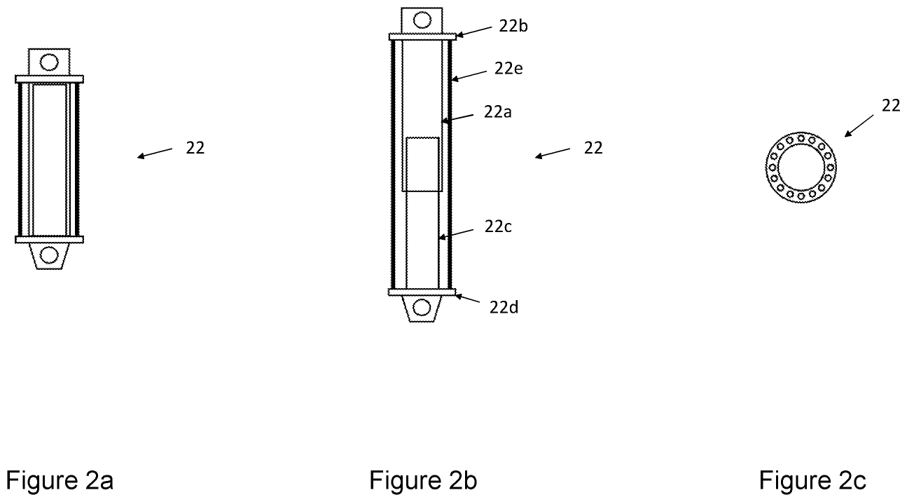

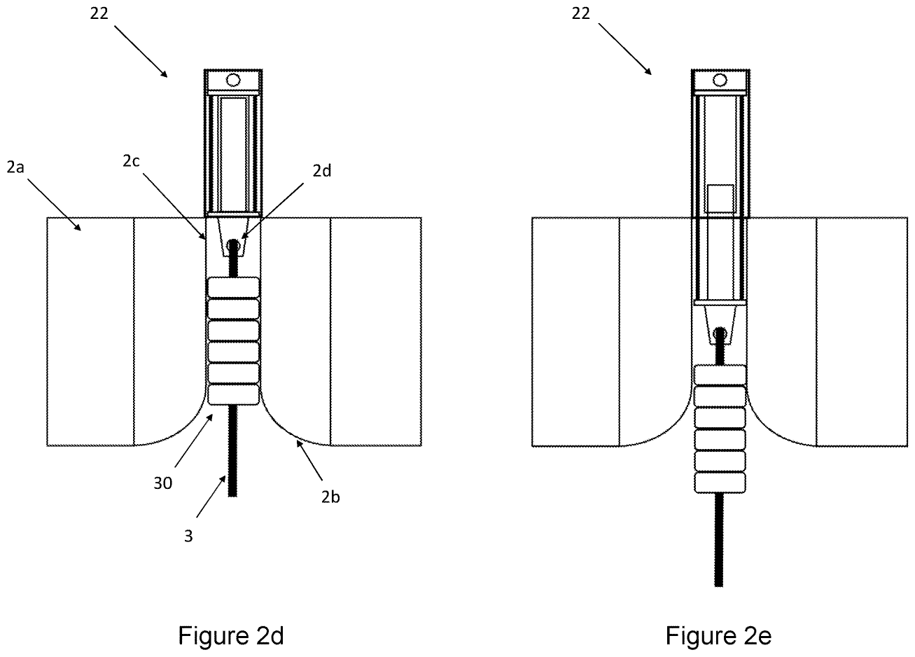

FIG. 2a shows the pre-tensed end-stop spring 22 in contracted state, and FIG. 2b shows the pre-tensed end-stop spring in extended state, the end-stop spring comprising a shell 22a having an inner diameter and with a top plate 22b having a pin hole. A rod 22c is connected to a bottom plate 22d with a bottom link with a hole for a connection to the mooring line 3, and rubber cords 22e attached between the top plate 22b and the bottom plate 22d, whereby the rod 22c, having an outer diameter slightly smaller than the inner diameter of the shell 22a, is adapted to move inside the shell. The rubber cords 22e are mounted with pre-tension between the top and bottom plates 22b, 22d when the rod 22c is fully inside the shell, to provide a total force higher than the pre-determined maximum control force, preferably 2.5 MN, even more preferably 2.0 MN. FIG. 2c shows a top view of the pre-tensed end-stop spring 20 with the rubber cords mounted in a circle around the shell. When the end-stop spring 22 is contracted again after a submerge event, the pressure in the air chamber increases with the reducing volume, providing a dampened return of the spring to avoid slamming into the fully contracted state.

FIG. 2d shows a cross section of the buoy 2 with a buoyant structure 2a and having a pipe 2c in the center with a bell opening or bell mouth 2b at the bottom, and with a shell of the pre-tensed end-stop spring 22 in contracted state. FIG. 2e shows the pre-tensed end-stop spring 22 in extended state, with guide blocks 30 around the mooring line 3 to provide low friction against the bell, to allow the spring to move with low friction force also when the buoy is tilted by the slope of a wave and/or distance away from the anchor point, and to protect the mooring line 3 from wear.

In summary, a pre-tensioned end stop spring device 22 is provided on top of the buoy, preferably by means of an elastic member, preferably rubber cord, pre-tensed between the end pieces of a shell and a rod inside the shell. The spring is activated when the pulling force exceeds the pre-tensed force, whereby the elastic member is stretched, and the rod extends out of the cylinder, whereby air is sucked into the enclosed volume inside the cylinder. When the spring is contracted again, the enclosed air in the cylinder is pushed out through the air gap between the cylinder and rod, creating a pressure drop acting as a cushion to dampen the return velocity and prevent slamming when the rod is fully contracted.

It will be realized that the same function can be provided with a hydraulic cylinder in tensile load, connected to a gas accumulator with a pre-charge gas pressure to provide the same pre-tensed force and similar spring function, the hydraulic cylinder preferably also providing damping by constraining the flow of oil from the cylinder, preferably with a metering pin or similar.

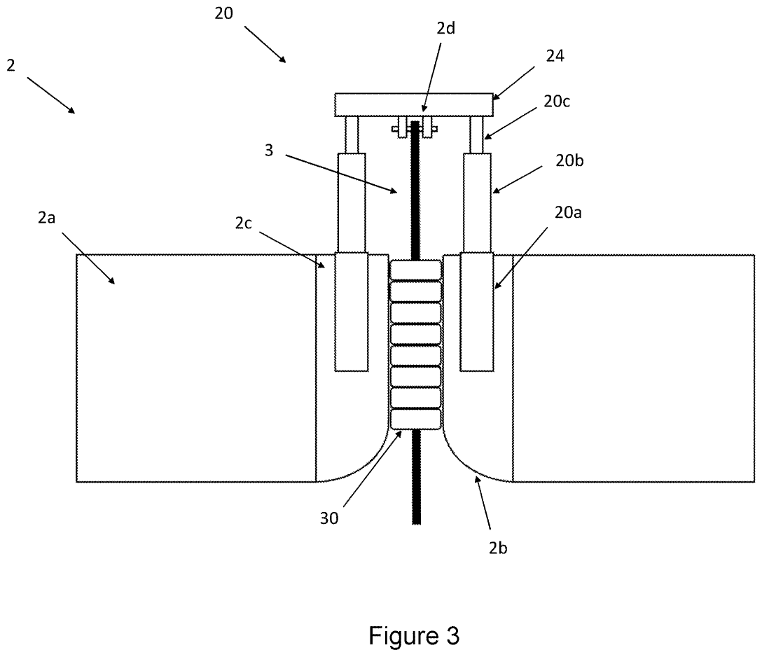

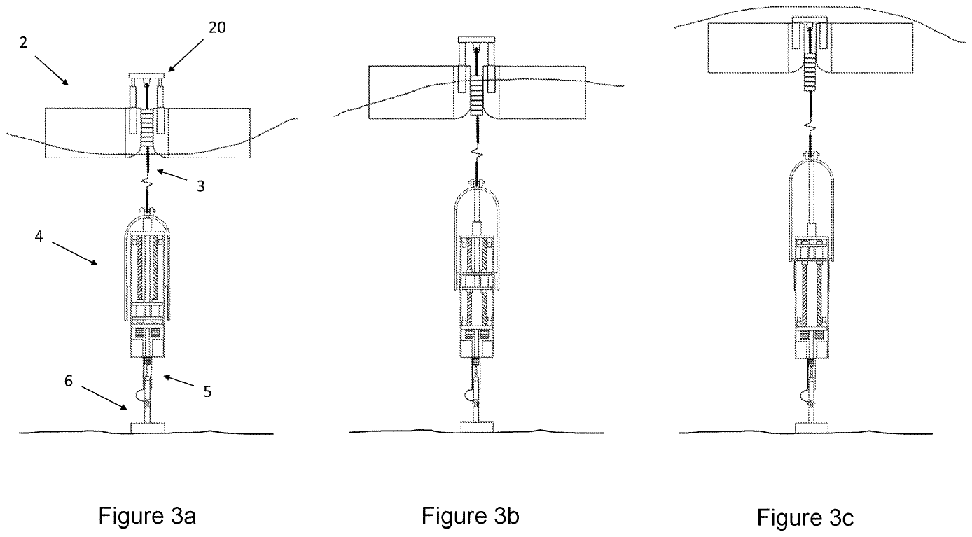

FIG. 3 shows an alternative embodiment of the buoy 2 with a buoyant structure 2a and a central structure 2c with mooring buffer assembly 20 comprising at least two spring/dampers, preferably three spring/dampers, preferably impact buffers, with cylinders 20a integrated with the central structure 2c on each side of/around the center through hole for the mooring line 3, whereby the load from the mooring line is distributed between multiple points in the buoy structure. Submerge buffer piston rod 20b extends up from cylinder 20a and slack buffer piston rod 20c extends up through the submerge buffer piston rods 20b in a telescopic arrangement. Both kinds of piston rods 20b, 20c are hollow and with a common internal gas volume, having a pressure to provide a pre-tensed spring force for the submerge buffer piston rod, preferably 2.5 MN, even more preferably 2.0 MN, to hold it fully extended when the force in the mooring line 3 is lower than the maximum control force applied by the PTO device 4, and with a diameter of the slack buffer piston rod 20c being selected to hold it fully compressed when the force in the mooring line is higher than the minimum control force, preferably 0.25 MN, together providing a fixed position of a mooring line connector 2d relative to the buoy 2 within the force control range of the PTO device 4, preferably from 0.25 to 2.25 MN, as shown in FIG. 3b.

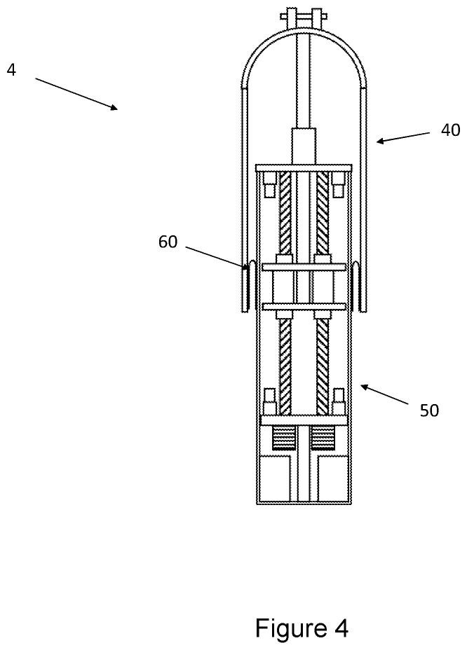

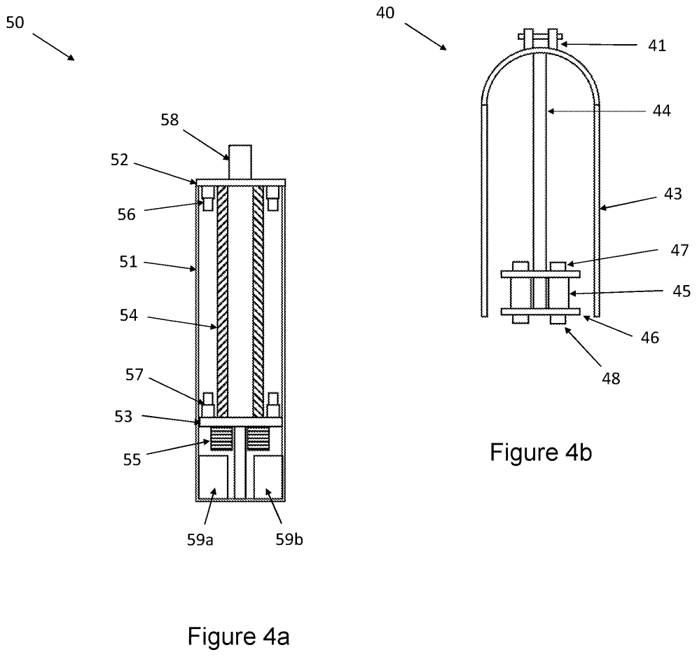

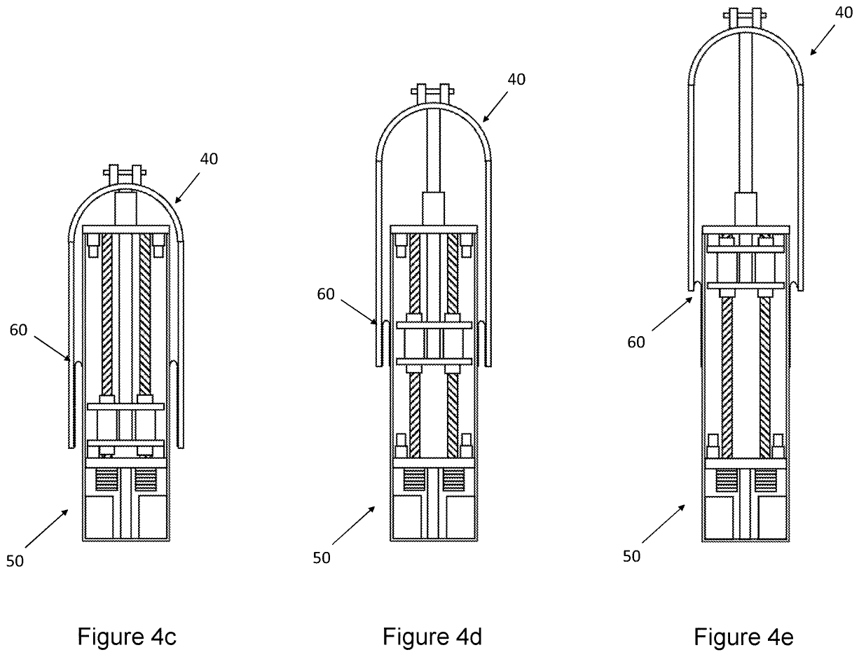

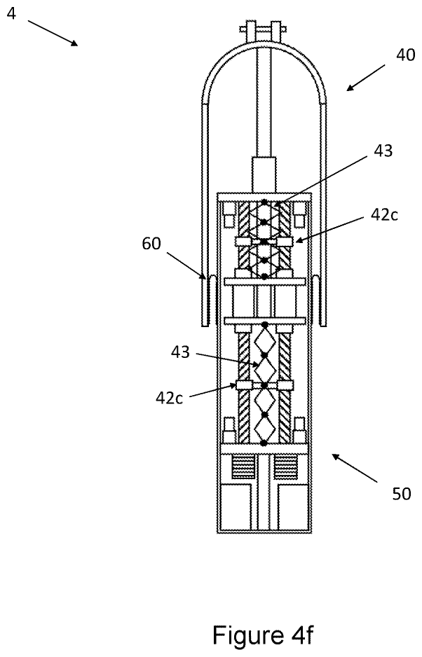

When the force in the mooring line 3 increases above the maximum control force by means of submerge buffers 56 in the PTO device 4, see FIG. 4a, due to a submerge event in a large wave crest, the submerge buffer piston rod 20c in the buoy 2 is being compressed, whereby the spring force increases while the buoy moves up relative to the mooring line, decelerating the buoys motion until it stops over an extended distance, reducing the maximum force in the mooring line during submerge events. FIG. 3c shows WEC unit 1 with the mooring spring/damper assembly 20 in fully compressed state during a submerge event. After a submerge event, the submerge buffer piston rod extends by means of spring force provided by the pre-charge gas pressure, to return the mooring line into its fixed position during normal operation.

When the force in the mooring line 3 is reduced below the minimum control force of the PTO device 4 by means of slack buffers 57 in the PTO, see FIG. 4a, during a slack event in a deep wave through, the slack buffer piston rod 20c in the buoy 2 is extended, moving the mooring line 3 upwards relative to the buoy 2, preferably 0.5 meters, as shown in FIG. 3a. When the slack event ends, the mooring line 3 is again tensed and the mooring force increases above the minimum control force, whereby the slack piston rod returns to its contracted state with a damping force higher than the pre-tension force, preferably 1.5 MN, whereby the heaving part 40 of the PTO is accelerated to match the speed of the buoy before the slack piston rod is fully contracted and the link between the buoy and PTO becomes stiff, to reduce the snap loads after a slack event in the mooring line.

It will be realized that the submerge buffers and slack buffers can be provided as separated components stacked on top of each other. A typical impact buffer comprises a cylinder and hollow piston rod containing the reservoir and internal gas volume, with the oil and gas separated by a floating piston. Pre-tension and spring force is provided by means of pre-charge gas pressure and the reduced gas volume as the piston contracts, damping force is provided by means of a metering pin that regulates the flow area from the cylinder to the reservoir. It should be realized that different types of impact buffers can be used, such as impact buffers with external reservoir and/or gas volume in an accumulator.

In order to further explain the two-stage end-stop cushioning system, reference is made to PTO DEVICE 4 shown in FIG. 4, comprising a heaving part 40 of the PTO device 4 with an outer PTO shell 43 and a fixed part 50 of the PTO device 4 comprising an inner PTO shell 51, wherein the outer PTO shell 43 is linearly movable relatively to the inner PTO shell 51. The outer and inner PTO shells 43, 51 together define an inner volume.

To seal the gap between the outer and inner PTO shells 43, 51, a flexible rolling membrane 60, see FIGS. 4 and 4a-c, is preferably used due to the relatively wide diameter. The membrane is in the form of a tube folded back into a double layer, whereby the outer layer is attached to the outer PTO shell 43 and the inner layer to the inner PTO shell 51, with the fold being placed upwards in the gap between the two shells. It should be realized that any suitable seal, can be used between the two shells, such as the types being used in hydraulic and pneumatic cylinders or other types of subsea cylinders, for example a linear seal.

FIG. 4a shows the fixed part 50 of the PTO device 4, comprising the inner PTO shell 51 and one pair of, preferably left and right cut, rotating ball screws 54 connected to top and bottom ball screw frames 52, 53. Submerge buffers 56 are connected to the ball screw top frame 52 and slack buffers 57 are connected to the bottom ball screw frame 53, preferably impact buffers, preferably with a hollow piston rod containing the reservoir and a floating piston which separates oil and gas, but can be of different types, such as elastomeric Diepocell impact buffer. FIG. 4b shows the heaving part 40 of the PTO device 4, comprising an outer PTO shell 43, one pair of non-rotating ball nuts in a ball nut frame 46, connected to the outer PTO shell 43 with a center guide rod 44, and the mooring line connector 41.

When the ball nut frame 46 reaches the submerge buffers 56, the force applied on the mooring line 3 increases above a pre-determined maximum control force, whereby the pre-tensed end-stop spring 20 in the buoy, shown in FIGS. 2a-b, is activated, increasing the mooring force acting on the buoy further while the spring is being extended, as shown in FIG. 2e, until the buoy motion stops. In this way the buoy 2 is held submerged under the crest of the wave with reduced maximum force in the mooring line.

The purpose of the pre-tensed end-stop spring 20 is to enable a stiff connection between the heaving part 40 of the PTO device 4 and the buoy 2 via the mooring line 3 during normal operation, and only activate the end-stop spring 20 when the submerge buffers 56 increase the mooring force above the pre-determined maximum control force. In this way, the buoy is stopped with the end-stop spring over an extended distance, preferably 1.5-2 meters, with a gradually increasing spring force, until the entire buoy 2 is submerged under the crest of the wave. The extended distance reduces the maximum end-stop force with approximately 50%, greatly reducing the structural loads through the entire system. Once the wave has passed by and the buoy surfaces again, the pre-tensed end-stop spring 20 returns to the contracted state and the PTO device 4 resumes normal operation with a stiff connection to the buoy 2 and continues to produce power.

FIGS. 4c-e show the PTO device according to FIG. 4 in three different positions of the heaving and fixed PTO parts 40, 50 according to FIGS. 4a, 4b: FIG. 4c shows a fully contracted PTO with the slack buffers 57 in compressed state, FIG. 4d shows a PTO in mid-stroke position during normal operation of the PTO and FIG. 4e shows a fully extended PTO with the submerge buffers 56 in compressed state.

The PTO device 4 shown in FIG. 4 also comprises a power extracting device connected between the outer and inner PTO shells 43, 51, being adapted to extract power, by applying a control force within a predetermined force range, as the heaving part 40 of the PTO device 4 moves with the buoy 2 in the waves while the fixed part 50 of the PTO device 4 is held in a fixed position by means of the anchor system 6. The PTO device 4 comprises a heave system with a pair of, preferably left and right cut, ball screws 54 being rotated, preferably in opposite directions, by non-rotating ball nuts in the ball nut frame during the heaving motion of the buoy, and motors/generators 55 connected to the bottom end of each rotating ball screw. The torque applied to the system by the motors 55 when driving or breaking the ball screws is thereby cancelled, preventing the outer and inner shells 43, 51 of the PTO hull 40, 50 to rotate. Guide bushings 47, 48 are preferably situated above and below the ball nuts on the ball nut frame to remove radial loads between the ball nut and ball screw, and guide bushing 58 mounted on top of the top ball screw top frame 52 to guide the center guide rod 44 and the outer PTO shell 43 to reduce bending moments and radial loads reaching the ball nut and ball screw. The outer PTO shell 43 moves up and down with the buoy 2, around the inner PTO shell 51 being fixed to the anchor.

FIG. 4f shows a PTO device 4 according to FIG. 4 with the addition of floating support frames 42c above and below the ball nut frame, positioned in the middle of the free length of the ball screws, preferably by means of a scissors lift mechanism 41c, 43c above and below the ball nut frame, with the purpose of increasing the critical speed of the ball screws to allow faster movement velocity of the heave system.

The purpose of this arrangement is to use the differential pressure between the surrounding water and the volume inside the PTO device 4 to provide a nearly constant pre-tension force from when the two PTO shells 43, 51 are being pushed together by the surrounding water pressure. The pre-tension force is preferably in the range of 1.0-1.5 MN, more preferably about 1.25 MN, which is achieved at approximately 70 meters depth (8 bar) by having a diameter in the range of 1-2 meters, preferably 1.5 meters diameter of the inner PTO shell 51. It should be realized that a different force can be provided by changing the depth and/or the diameter of the inner PTO shell 43. The average pressure inside the PTO hull is in the range of 0.5-1.0, preferably about ¾ of the atmospheric pressure (0.75 bar) on an average, whereby the average differential pressure is 7.25 bar, which is achieved by equalizing the pressure inside the PTO device 4 with the heave system in fully contracted state before deploying the PTO into the water. In this way the pressure inside the PTO device 4 reduces to approximately 0.5 bar when the PTO device 4 is fully extended.

Below the heave system of FIGS. 4a and 4b are the ball screw motors/generators 55 and a space 59a, 59b for power electronics and control system.

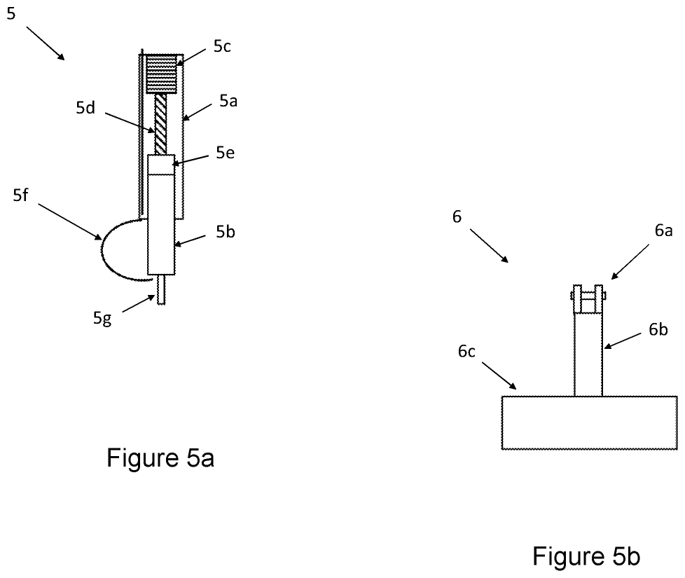

A level cylinder 5, as shown in FIG. 5a, is provided below the PTO device 4 to align the height of the PTO device 4 with the water level when it changes due to tides etc. The level cylinder 5 is preferably actuated by a roller screw with a motor 5c at the top to rotate the screw 5d, and the roller nut 5e at the top of rod 5b extending from cylinder 5a at the bottom. The power cable goes down through the level cylinder, on to quick connector 5g via a loop to handle the movement of the level cylinder, and further down through the anchor system 6 according to FIG. 5b, with the lower part of the quick connector 6a, a transition rod 6b adapted to position the PTO on a specific height above the seabed to achieve the required pressure differential in the hydrostatic pre-tensioning system, which is located below the quick connector to have all quick connectors in an array of WEC units on the same depth. The level cylinder 5 can alternatively be a hydraulic cylinder or a winch. The purpose of the transition rod is to have a single component that is adopted for different heights in the seabed, enabling a specific PTO model to be designed for a single depth.

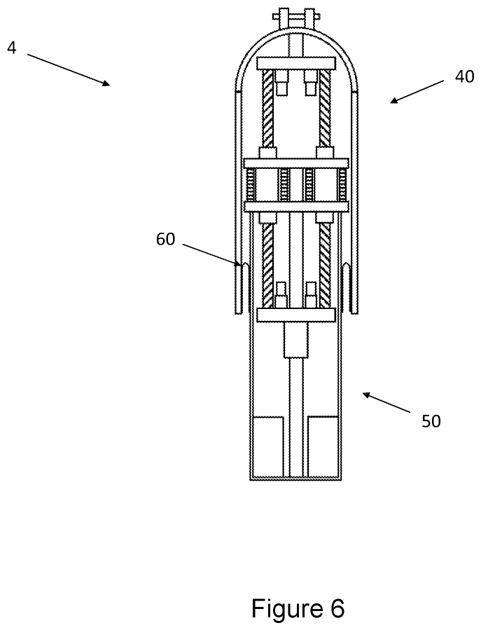

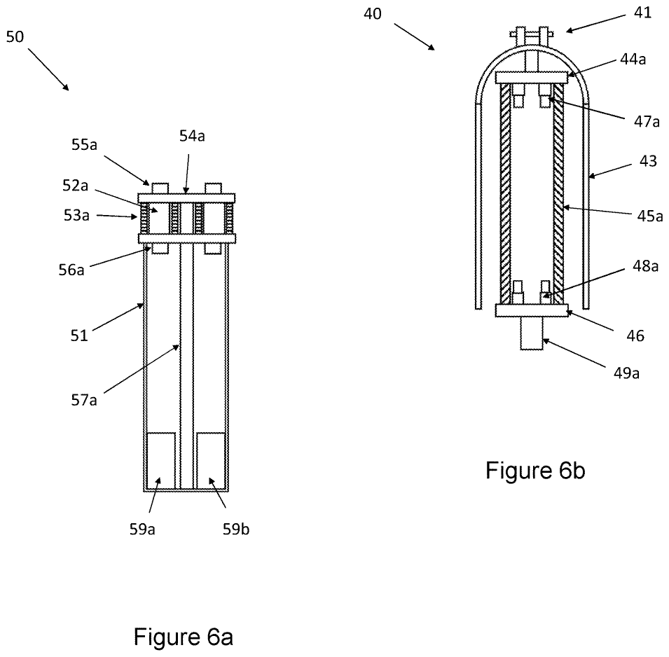

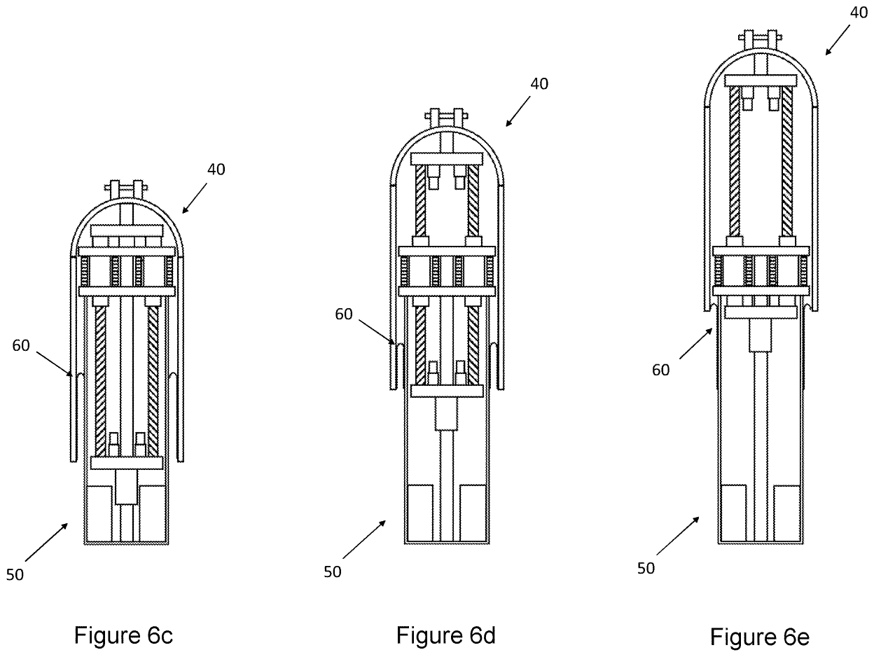

FIG. 6 shows an alternative PTO device 4, similar to the one shown in FIG. 4, but with an actuation system comprising heaving non-rotating ball screws and fixed rotating ball nuts. FIG. 6a shows the fixed part 50 of the PTO device 4 comprising rotating ball nuts 52a held in a fixed vertical position by center guide rod 57a, with a hollow rotor of the motor/generator 53a mounted around each rotating ball nut 52a, connected with the ball nut frame 54a via thrust bearings. Guide bushings 55a, 56a are preferably located above and below the ball nut frame 54a, and electrical cabinets 59a, 59b for control system and power electronics are located at the bottom of the inner PTO shell 50a. FIG. 6b shows the heaving part 40 of the PTO device 4, with non-rotating ball screws 45a between top and bottom ball screw frames 44a, 46a. Submerge cushions 48a are connected to the bottom ball nut frame 46a and slack cushions 47a are connected to the top ball nut frame 44a. Linear guiding is provided mainly by center guide rod 57a in the fixed part 50 of the PTO device 4 and guide bushing 49a in the heaving part 40 of the PTO device 4, absorbing radial loads and bending moments between the two parts of the PTO, and preferably with guide bushings 55a, 56a on the ball screw, to reduce radial loads between ball nut and ball screw. FIGS. 6c-e show PTO device 4 in three different positions: fully contracted with the slack buffers being compressed as shown in FIG. 6c, mid-stroke as shown in FIG. 6d, and fully extended with the submerge buffers compressed as shown in FIG. 6e.

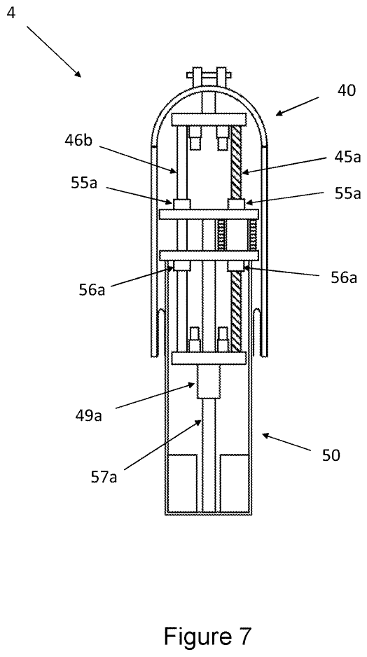

FIG. 7 shows an alternative embodiment of a PTO device 4, similar to the one of FIG. 6, but with guide rods 46b in parallel with the ball screws, preferably two guide rods, and one pair of, preferably right and left cut, ball screws 46a, whereby the guide rods provide additional support to absorb radial loads and bending moments between the heaving and fixed parts 40, 50, respectively, of the PTO device 4, with the purpose to reduce the mentioned loads on guide bushings 55a, 56a for the ball screws 46a.

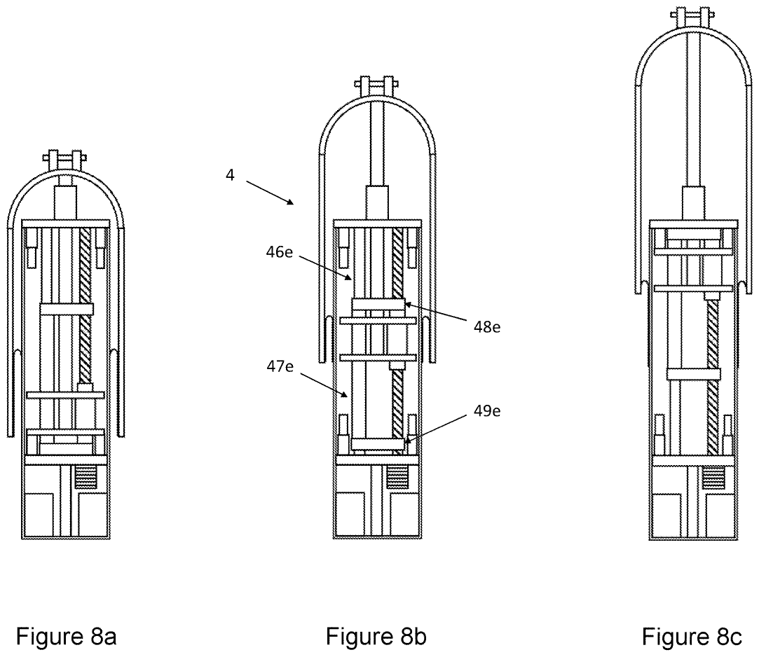

FIGS. 8a-c show a PTO device 4 similar to the one of FIG. 4, with the addition of guide rods 46e shown in FIG. 7, and a guide pipe 47e running on the guide rods, with upper and lower floating support frames 48e, 49e with a fixed distance from each other, comprising bushings for all guide rods and ball screws horizontally fixed relative each other, with one floating support frame on each side of the ball nut frame. FIG. 8a showing the PTO device 4 in fully contracted state, with the upper floating support frame 48e being positioned in the middle of the free length of the ball screws above the ball nut frame, FIG. 8b shows the upper floating support frame 48e being lifted by the ball nut frame when the PTO device is extended beyond mid-stroke, whereby the lower support frame moves upwards over the fee length of the ball screw below the ball nut frame. FIG. 8c shows the PTO device 4 in fully extended position, with the lower floating support frame positioned in the middle of the free length of the ball screw below the ball nut frame. Thereby a floating support guide for the ball screw is provided which reduces the maximum free length of the ball screws to half, thereby increasing the critical speed for the ball screws and the maximum heaving velocity allowed for the actuation system.

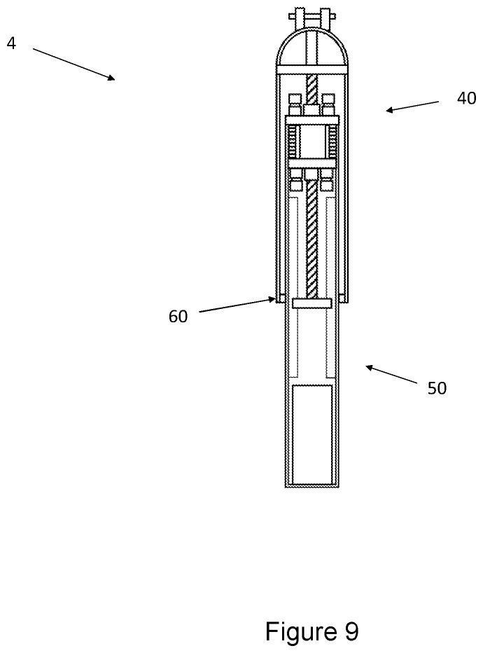

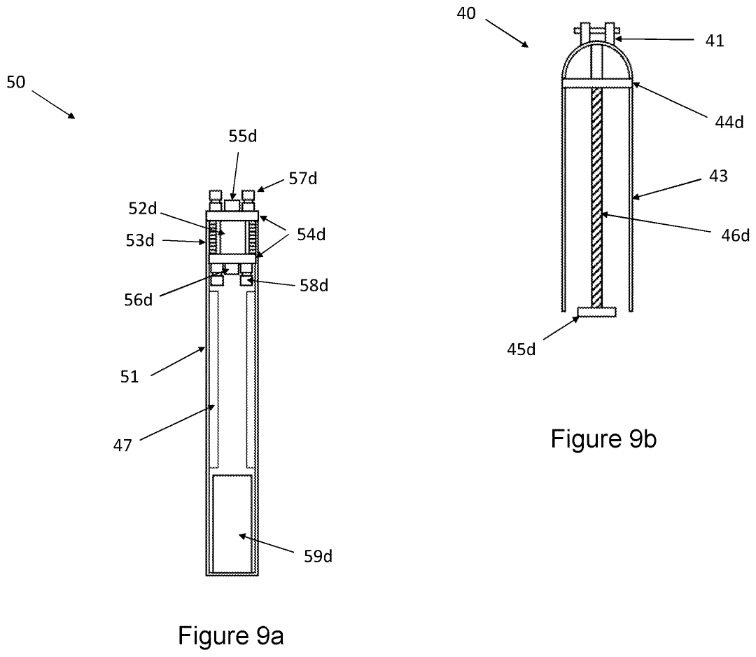

FIG. 9 shows an alternative embodiment of a PTO device 4, similar to the one of FIG. 6, but with only one ball screw. In this way, the diameter of the PTO device 4 can be smaller relative to the force provided. This embodiment is preferably used at greater water depth where the smaller diameter of the inner PTO shell still provides the required pre-tension force by having a larger differential pressure. 1 m diameter of the inner PTO shell 51 at 160 meters depth can preferably be used to provide 1.25 MN, or preferably providing 0.6 MN pre-tension force at 80 meters depth in a PTO device 4 with half the force capacity preferably used in milder wave climates.

With a smaller diameter of the outer and inner PTO shells 43, 51, linear seals 60 between the shells are preferably used, although the flexible rubber membrane as described above can also be used. To prevent rotation due to the motor/generator torque, a linear guide is provided, as shown by FIG. 9a, preferably between the inside of the Inner PTO shell 51 and the ball screw bottom frame 45 and/or at the upper guide bushing 55 between the outer PTO shell 43 and the ball nut frame.

A wave energy converter (WEC) unit with a power take-off (PTO) device comprising a heave system with two ball screw actuators and a differential pressure pre-tensioning system comprising a PTO hull split into an outer shell movable up and down around an inner shell, a linear guide system to absorb radial loads and bending moments between the two shells and to radially align the ball screws with the ball nuts, a two stage end-stop system with impact buffers in the power take-off to limit the stroke of the heave system and a second stage with pre-tensed end-stop spring/dampers in the buoy to reduce mooring loads by allowing the buoy to move relative to the mooring line with a decelerating spring/damper force only when force in the mooring line is below or above the force control range, and a level cylinder to adjust for tidal variations and an anchor system with a transition rod to position a quick connector and power take-off on a specific depth, has been shown and described. It will be realized that the different shown embodiments of the PTO device can be combined in any way and implemented with a different number of ball screws, and different pre-tension and control forces, than the numbers defined by the appended claims. For example, any number between one and six ball screw actuators, pre-tension force between 0.5-2.25 together with a bi-directional control force with an amplitude 0-0.5 MN lower than the amplitude of the pre-tension force.

Two PTO shells have been described: a first outer PTO shell 43 connected to the buoy 2 and a second inner PTO shell 51 connected to the anchor 6, with a telescoping function allowing the inner PTO shell 51 to move inside the outer PTO shell 43. It will be realized that the upper PTO shell, i.e., the first PTO shell 43, instead may move inside the lower PTO shell, i.e., the second PTO shell 51.

It should be realized that the two-stage end stop cushion system, the level cylinder and the differential pressure pre-tensioning system can be combined with any type of suitable linear actuators in addition to ball screws, having the purpose of extracting power from the system, such as rack and pinion, any type of power screw, magnetic screw, linear electromagnetic actuator, linear generator, hydraulic cylinder connected to a hydraulic motor and generator or a Pelton turbine.

Pre-tensioned end stop spring devices 20 and 20a has been described, provided on top of the buoy 2. It will be realized that these pre-tensioned end stop spring devices can be used in other designs of a WEC than the ones described herein.

Certain embodiments or components or features of components have been noted herein as being “preferred” and some options as being “preferable” or the like and such indications are to be understood as relating to a preference of the applicant at the time this application was filed. Such embodiments, components or features noted as being “preferred” or “preferable” or the like are optional and are not required for implementation of the innovations disclosed herein unless otherwise indicated as being required, or specifically included within the claims that follow.

1. A power take-off device for use in a wave energy converter unit having a buoy, the power take-off device having:
a power take-off hull connectable to a mooring device,
the power take-off hull being connected to or connectable to the buoy, preferably by means of a mooring line, and
a power extracting device connected to the power take-off hull and adapted to extract power as the buoy moves with the waves, by applying a control force within a predetermined range,
wherein
the power take-off hull comprises a first shell and a second shell, the first shell being movable relatively to the second shell, the first and second shells together defining an inner volume,
wherein a seal is provided to separate the inner volume from water outside of the power take-off hull, and
wherein the differential pressure between water surrounding the power take-off hull and the inner volume is used to, during operation, provide a nearly constant pre-tension force from the first and second shells being pushed together by surrounding water pressure.

2. The power take-off device according to claim 1, wherein the seal comprises a flexible rubber membrane arranged to roll between the first and second shells during movement.

3. The power take-off device according to claim 1, wherein the seal comprises a linear seal.

4. The power take-off device according to claim 1, wherein the pre-tension force is in the range of 0.5-1.5 MN, preferably about 1.25 MN, preferably provided together with a bi-directional control force with a slightly lower amplitude, preferably about 0.25 MN lower, the two forces together providing a force control range, preferably 0.25-2.25 MN.

5. The power take-off device according to claim 1, wherein the diameter of the second shell is in the range of 1-2 meters, preferably 1.5 meters.

6. The power take-off device according to claim 1, comprising a power take-off heave system with at least one pair of, preferably left and right cut, rotating ball screws, and non-rotating ball nuts being fixed in a frame, preferably with guide bushings between the ball nuts and ball screws, and preferably with a central guide pipe being attached to the ball nut frame, sliding through a linear guide bushing in the ball screw frame.

7. The power take-off device according to claim 6, comprising guide rods arranged in parallel with the ball screws, preferably also sliding through guide bushings in the ball nut frame, to further reduce radial forces and bending moments from the ball screws.

8. The power take-off device according to claim 7, comprising a floating support bushing assembly for the ball screws, the floating support bushing assembly comprising a frame of guide bushings on each side of the ball nuts with a fixed distance between the frames, preferably by means of guide pipes, preferably running on the guide rod, the floating support bushing assembly preferably being lifted by the bottom frame for the ball screws and guide rods from half the way through the up stroke, reducing the maximum free length of the ball screws above the ball nut frame to half, and the floating support bearing assembly resting on top of the ball nut frame from half the way through the down stroke, reducing the maximum free length of the ball screws below the ball nut frame to half, whereby the critical speed of the ball screws are increased, allowing faster movement velocity.

9. The power take-off device according to claim 8, comprising at least one frame with floating support bushings for the ball screws on each side of the ball nut frame, is positioned on the ball screws with a scissors lift mechanism between each of the ball screw frames and the ball nut assembly, whereby the floating support bushings are always positioned evenly across the free length of the ball screw through the length of the stroke.

10. The power take-off device according to claim 1, comprising a power take-off heave system with at least one pair of, preferably left and right cut, non-rotating ball screws heaving with the buoy, and rotating ball nuts held in a fixed vertical position.

11. A wave energy converter comprising a power take-off device according to claim 1, a buoy connected to the first shell of the power take-off hull and an anchor system connected to the second shell of the power take-off hull.

12. The wave energy converter according to claim 11, wherein the buoy comprises a pre-tensed end-stop spring comprising a shell with a top plate and having an inner diameter and, a rod connected to a bottom plate with a bottom link for a connection to a mooring line, and rubber cords attached between the top plate and the bottom plate, wherein the rod, having an outer diameter slightly smaller than the inner diameter of the shell, is adapted to move inside the shell, and wherein the rubber cords are mounted with pre-tension between the top and bottom plates when the rod is fully inside the shell, to provide a total force higher than the pre-determined maximum control force, preferably 2.5 MN, more preferably 2.0 MN.

13. The wave energy converter according to claim 11, wherein the buoy comprises a submerge end-stop spring/damper system comprising at least two dampers around a through hole in the buoy for the mooring line, the dampers preferably being impact buffers, preferably with a submerge buffer piston rod comprising a reservoir and a floating piston which separates oil and gas, and wherein the gas has a pre-charge pressure corresponding to a force higher than the maximum control force, whereby the buoy submerge spring/damper system is compressed by the increased force in the mooring line from the power take-off submerge end-stop dampers during buoy submerge events in large waves.

14. The wave energy converter according to claim 13, comprising a slack end-stop spring/damper system in the buoy in combination with the submerge end-stop spring/damper system, the slack end-stop spring/damper system preferably comprising at least two impact buffers around the through hole in the buoy for the mooring line, preferably with the piston rod containing a reservoir and a floating piston which separates oil and gas, wherein the gas has a pre-charge pressure corresponding to a force lower than the minimum control force, whereby the buoy slack spring/damper system is compressed within the force control range, extended during slack events when the force in the mooring line is lower than a minimum control force of the predetermined range, and returned to compressed state with a damping force higher than the pre-tension force after the slack event when the force in the mooring line returns.

15. The wave energy converter according to claim 11, comprising an end-stop spring/damper system in the buoy with a slack buffer piston rod integrated in the submerge spring/damper system, the slack buffer piston rod preferably extending from a submerge buffer piston rod of the submerge end-stop spring/damper system to operate with the same pre-charge pressure and gas volume, to provide a pre-tensed force of the slack buffer piston rod lower than a minimum control force of the predetermined range when fully compressed, whereby the slack buffer piston rod extends when the force in the mooring line is lower than the minimum control force due to a slack event, activating a snap load damper function to apply a damping force while the slack buffer piston rod returns to the compressed state when the mooring line is tensed again after the slack event and the force increases above the minimum control force, to accelerate power take-off heave motion to match a buoy velocity before the slack buffer piston rod is fully compressed and the mooring line between the buoy and power take-off becomes stiff, to reduce snap loads.

16. A method of operating a power take-off device according to claim 1, wherein the constant force provided by the differential pressure of the water surrounding the power take-off hull and the inner volume, is used in combination with a controllable bi-directional force provided by a linear actuator.

17. The method according to claim 16, wherein an average pressure of the inner volume is in the range of 0.5-1.0 bar, preferably about 0.75 bar.

18. The method according to claim 16, wherein the differential pressure is about 7.25 bar.
